(19) United States
(12) Patent Application Publication
(10) Pub. No.: US 2022/0398199 A1
(43) Pub. Date: Dec. 15, 2022

(54) USER-SPACE REMOTE MEMORY PAGING

(71) Applicant: VMware, Inc., Palo Alto, CA (US)

(72) Inventors: Irina Calciu, Palo Alto, CA (US); Muhammad Talha Imran, State College, PA (US); Nadav Amit, Mountain View, CA (US)

(21) Appl. No.: 17/348,529

(22) Filed: Jun. 15, 2021

(51) Int. Cl. G06F 12/0882; G06F 12/1045; G06F 12/02; G06F 9/50; G06F 11/07; G06F 15/173

(52) U.S. Cl. CPC G06F 12/0882; G06F 12/1063; G06F 12/0238; G06F 9/5016; G06F 11/0772; G06F 15/17331

(57) ABSTRACT

Techniques for implementing user-space remote memory paging are provided. In one set of embodiments, these techniques include a user-space remote memory paging (RMP) runtime that can: (1) pre-allocate one or more regions of remote memory for use by an application; (2) at a time of receiving/intercepting a memory allocation function call invoked by the application, map the virtual memory address range of the allocated local memory to a portion of the pre-allocated remote memory; (3) at a time of detecting a page fault directed to a page that is mapped to remote memory, retrieve the page via Remote Direct Memory Access (RDMA) from its remote memory location and store the retrieved page in a local main memory cache; and (4) on a periodic basis, identify pages in the local main memory cache that are candidates for eviction and write out the identified pages via RDMA to their mapped remote memory locations if they have been modified.

### BACKGROUND

Unless otherwise indicated, the subject matter described in this section is not prior art to the claims of the present application and is not admitted as being prior art by inclusion in this section.

Memory paging is a memory management technique that temporarily moves (i.e., swaps) data in the form of fixed-size pages from a computer system's main memory to secondary storage at times when the amount of available main memory is low. Among other things, this allows the memory footprints of applications running on the computer system to exceed the size of main memory. If an application attempts to access a page that is currently swapped out to secondary storage, a page fault is raised and the page is swapped back into main memory for use by the application.

Remote memory paging is a variant of memory paging that holds swapped-out pages in the main memory of another computer system (i.e., remote memory) rather than secondary storage, which can be beneficial in certain scenarios. For example, consider a cluster of servers that are connected via a high-bandwidth, low-latency network (e.g., a network that supports end-to-end latencies on the order of a few microseconds or less). In this scenario, remote memory paging will generally result in better system performance than traditional memory paging because swapping pages to and from remote memory over such a network is faster than swapping pages to and from disk.

One approach for implementing remote memory paging involves modifying an operating system (OS) or hypervisor kernel to support its required features (e.g., remote memory allocation/deallocation, remote memory page fault handling, etc.). However, this kernel-level approach suffers from several drawbacks. For example, because kernel modifications are tied to a particular kernel version, any changes made to one kernel version must be ported to new kernel versions. Further, this approach is difficult to implement in practice due to the need to integrate with kernel code. Yet further, a kernel-level implementation complicates upgrade management in production deployments because it requires the kernel to be rebooted (and all applications running on the kernel to be terminated and restarted) for every patch/upgrade.

### BRIEF DESCRIPTION OF THE DRAWINGS

FIG. 1 depicts a system environment according to certain embodiments.

FIG. 2 depicts a remote memory export workflow according to certain embodiments.

FIG. 3 depicts a remote memory pre-allocation workflow according to certain embodiments.

FIG. 4 depicts a local memory allocation workflow according to certain embodiments.

FIG. 5 depicts a user-space page fault handling workflow according to certain embodiments.

FIG. 6 depicts an eviction handling workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

The present disclosure is directed to techniques for implementing remote memory paging in user space (or in other words, without kernel modifications). “User space” refers to the portion of main memory of a computer system that is allocated for running user (i.e., non-kernel) processes/applications. In contrast, “kernel space” is the portion of main memory that is dedicated for use by the kernel.

At a high level, the techniques of the present disclosure include a novel user-space remote memory paging (RMP) runtime that can: (1) pre-allocate one or more regions of remote memory for use by an application; (2) at a time of receiving/intercepting a memory allocation function call invoked by the application, map the virtual memory address range of the allocated local memory to a portion of the pre-allocated remote memory; (3) at a time of detecting a page fault directed to a page that is mapped to remote memory, retrieve the page via Remote Direct Memory Access (RDMA) from its remote memory location and store the retrieved page in a local main memory cache; and (4) on a periodic basis, identify pages in the local main memory cache that are candidates for eviction and write out the identified pages via RDMA to their mapped remote memory locations if they have been modified. Step (3) assumes that the user-space RMP runtime is empowered to handle the application's page faults via a kernel-provided page fault delegation mechanism such as userfaultfd in Linux.

With this user-space runtime, the drawbacks associated with kernel-level remote memory paging solutions (e.g., lack of portability, difficult development, complex upgrade management, and so on) can be largely mitigated or avoided. The foregoing and other aspects are described in further detail in the sections below.

### 2. System Environment

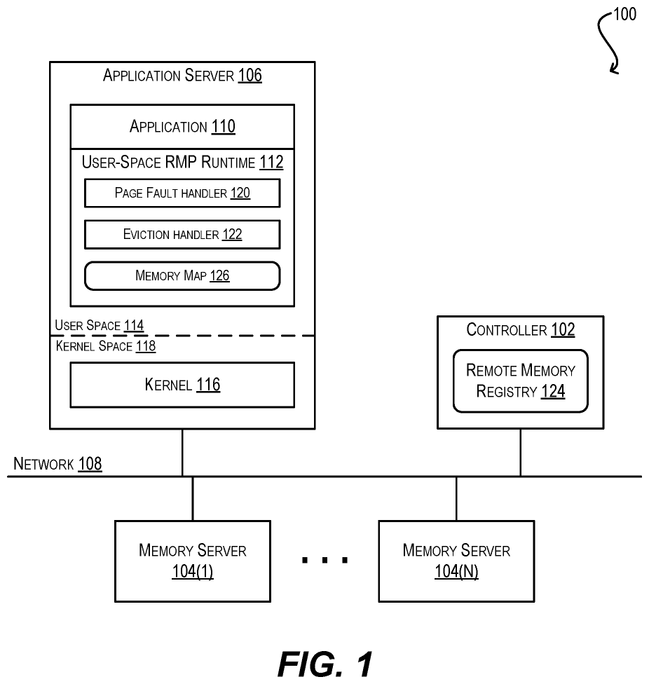

FIG. 1 is a simplified block diagram of a system environment 100 that implements the techniques of the present disclosure. As shown, system environment 100 includes a controller 102 that is communicatively coupled with a set of memory servers 104(1)-(N) and an application server 106 via a high-bandwidth, low-latency network 108. For example, in a particular embodiment network 108 may be an InfiniBand or 100/400G Ethernet network. Memory servers 104(1)-(N) and application server 106 are RDMA capable and thus can directly transfer data between their respective main memories (e.g., RAM modules) via RDMA reads and writes over network 108.

Application server 106 includes an application 110 and a user-space remote memory paging (RMP) runtime 112 running in the server's user space 114, as well as an OS/hypervisor kernel 116 running in the server's kernel space 118. Kernel 116 may be, e.g., the Linux kernel or any other OS or hypervisor kernel that provides a user-space page fault delegation mechanism that is functionally similar to Linux's userfaultfd. User-space RMP runtime 112—which comprises code that is executed during the runtime of application 110—further includes a page fault handler 120 and an eviction handler 122. In one set of embodiments, user-space RMP runtime 112 can be implemented as a software library that is statically or dynamically linked to application 110. In other embodiments, user-space RMP runtime 112 can be implemented as a standalone process that interacts with software application 110 via inter-process communication.

In operation, memory servers 104(1)-(N) are configured to export regions (referred to as “slabs”) of their local main memories as remote memory by registering the slabs for RDMA access and sending remote memory information to controller 102 that includes the slabs' RDMA access details. These details can comprise, e.g., the virtual memory starting address and size of each slab, a network address and port of the memory server, and an RDMA key of the memory server.

Controller 102 is configured to receive the remote memory information sent by memory servers 104(1)-(N) and store this information in a remote memory registry 124, thereby tracking the available remote memory in system environment 100. In addition, controller 102 is configured to receive remote memory allocation/deallocation requests from user-space RMP runtime 112 and process the requests in accordance with the information in remote memory registry 124. For example, upon receiving a request from user-space RMP runtime 112 to allocate a remote memory slab to application 110, controller 102 can identify a free slab in remote memory registry 124, assign/allocate the slab to application 110, and return the slab's RDMA access details to user-space RMP runtime 112 so that it can be directly accessed by runtime 112/application 110.

User-space RMP runtime 112 is configured to expose an application programming interface (API) to application 110 that enables the application to make use of remote memory (or more precisely, enables the application to allocate and deallocate local memory that is backed by remote memory for paging purposes). For example, this API can include remote memory-enabled versions of the standard malloc, free, and mmap function calls in the standard library of the C/C++ programming language, such as “rmalloc,” “rfree,” and “rmmap.” User-space RMP runtime 112 is also configured to pre-allocate batches of remote memory for use by application 110 by communicating with controller 102 as described above and storing the RDMA access details of the remote memory in a local memory map 126.

With these pre-allocations in place, at the time of receiving an invocation of a remote memory-enabled memory allocation function call from application 110 (e.g., a call to rmalloc or rmmap), user-space RMP runtime 112 can allocate the requested amount of memory in the virtual address space of application 110 and map the address range of this allocated virtual (i.e., local) memory to a portion of pre-allocated remote memory in memory map 126, thereby designating that remote memory as a swap backing store (or in other words, a destination for holding swapped-out data) for the allocated local memory. In addition, user-space RMP runtime 112 can register the virtual address range of the allocated local memory with kernel 116's page fault delegation mechanism, which will cause kernel 116 to notify user-space RMP runtime 112 of future page faults pertaining to that range.

Page fault handler 120 is a subcomponent (e.g., thread) of user-space RMP runtime 112 that is configured to monitor for page faults delivered by kernel 116's page fault delegation mechanism with respect to remote memory mapped to the allocated local memory of application 110, per the allocation process above. In response to detecting a page fault for a given memory page P, page fault handler 120 can identify, via memory map 126, the remote memory location (i.e., memory server, slab, and address range within the slab) that backs page P, retrieve the contents of P from that remote memory location via an RDMA read, and place P in a local main memory cache (not shown) for access by application 110.

Finally, eviction handler 122 is a subcomponent (e.g., thread) of user-space RMP runtime 112 that is configured to periodically check the utilization of the main memory cache associated with application 110. If the cache's utilization exceeds a threshold, eviction handler 122 can identify one or more pages in the main memory cache that are candidates for eviction (e.g., have not been accessed by application 110 recently) and can write out those pages to their mapped remote memory locations via RDMA writes (if they have been modified) and drop the pages from the main memory cache. In this way, eviction handler 122 can ensure that application 110's main memory cache has sufficient free space to hold new pages that may be swapped in from remote memory due to new memory accesses by the application. In certain embodiments, eviction handler 122 can also perform a “cleanup” function that proactively writes out dirty pages in the main memory cache to their remote memory locations in a lazy manner.

With the general architecture shown in FIG. 1 and described above, a number of advantages are achieved over kernel-based remote memory paging solutions. First, because user-space RMP runtime 112 is implemented entirely in user space, it can be used with different versions of kernel 116 without issue; the only limitation on kernel 116 is that it should provide a user-space page fault delegation mechanism in order to support the operation of the runtime's page fault handler 120.

Second, by virtue of being separate from kernel 116, user-space RMP runtime 112 simplifies development and allows for easy upgrades.

Third, this architecture can flexibly accommodate additional features and optimizations pertaining to remote memory paging that would be difficult or infeasible to implement at the kernel level. For example, in certain embodiments, user-space RMP runtime 112 may include a function interposer that is configured to intercept standard memory allocation/deallocation function calls like malloc, free, and mmap and translate these standard calls into their respective remote memory-enabled versions (i.e., rmalloc, rfree, and rmmap). This allows user-space RMP runtime 112 to transparently support remote memory paging for legacy applications. For new applications that are aware of the remote memory API exposed by runtime 112, this function interposer can be disabled, thereby providing those new applications the choice of using remote memory (via calls to rmalloc, rfree, and rmmap) or not (via calls to standard malloc, free, and mmap) for different in-memory data structures.

The remaining sections of this disclosure provide additional details regarding the workflows that may be executed by controller 102, memory servers 104(1)-(N), user-space RMP runtime 112, page fault handler 120, and eviction handler 122 for enabling user-space remote memory paging, as well as certain enhancements and optimizations to their design/operation (including the function interposition noted above). It should be appreciated that FIG. 1 is illustrative and not intended to limit embodiments of the present disclosure. For example, although FIG. 1 depicts a particular arrangement of entities and components within system environment 100, other arrangements are possible (e.g., the functionality attributed to a particular entity/component may be split into multiple entities/components, entities/components may be combined, etc.). Further, the various entities/components shown may include subcomponents and/or functions that are not specifically described. One of ordinary skill in the art will recognize other variations, modifications, and alternatives.

### 3. Remote Memory Export

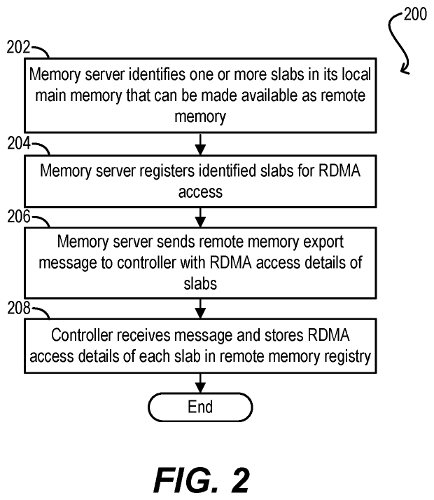

FIG. 2 depicts a workflow 200 that may be executed by each memory server 104 and controller 102 of FIG. 1 for exporting portions (i.e., slabs) of the main memory of server 104 for use as remote memory according to certain embodiments.

Starting with block 202, memory server 104 can identify one or more slabs of its main memory that can be made available as remote memory to other servers in system environment 100, including application server 106. These slabs may correspond to portions of server 104's main memory that are mostly under-utilized.

At block 204, memory server 104 can register the identified slabs for RDMA access, which generally involves informing an RDMA-capable network interface controller (NIC) of the server that these slabs should be accessible via RDMA. Memory server 104 can then send a remote memory export message to controller 102 that specifies the RDMA access details of the slabs, including the starting virtual address and size of each slab, the network (e.g., IP) address and port of memory server 104, and the RDMA key of memory server 104 (block 206).

Finally, at block 208, controller 102 can receive the remote memory export message from memory server 104 and store the details of each slab (along with an indicator indicating that the slabs are currently unallocated) in its remote memory registry 124.

### 4. Remote Memory Pre-Allocation

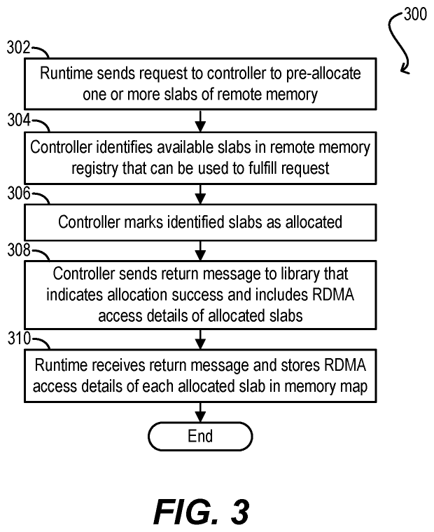

FIG. 3 depicts a workflow 300 that may be executed by user-space RMP runtime 112 and controller 102 for pre-allocating remote memory for use by application 110 according to certain embodiments. This pre-allocation avoids the need for user-space RMP runtime 112 to allocate remote memory as part of processing every local memory allocation function call invoked by application 110, and thus accelerates the local allocation critical path. Workflow 300 can be executed at the time of application startup, as well as whenever the amount of free (i.e., unmapped) remote memory allocated to application 110, as recorded in memory map 126, falls below a low watermark.

Starting with block 302, user-space RMP runtime 112 can send a request to controller 102 to pre-allocate one or more slabs of remote memory for application 110. The specific number of slabs that are requested is configurable and can vary depending on the nature of application 110.

At block 304, controller 102 can identify available slabs in remote memory registry 124 that can be used to fulfill the request. Controller 102 can then mark the identified slabs as being allocated (block 306) and can send a return message to user-space RMP runtime 112 that indicates the allocation is successful and includes the RDMA access details of the allocated slabs (block 308).

Finally, at block 310, user-space RMP runtime 112 can receive the return message from controller 102 and store the details of each allocated slab in its memory map 126.

### 5. Local Memory Allocation Processing

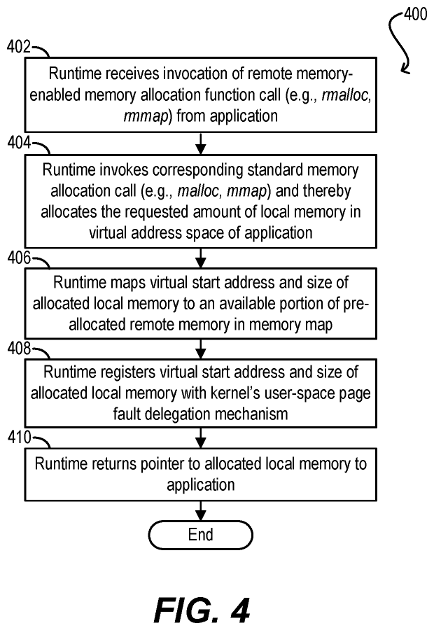

FIG. 4 depicts a workflow 400 that may be executed by user-space RMP runtime 112 for processing a remote memory-enabled local memory allocation function call invoked by application 110 according to certain embodiments. Workflow 400 assumes that user-space RMP runtime 112 has pre-allocated some amount of remote memory for use by application 110 per workflow 300 of FIG. 3.

Starting with block 402, user-space RMP runtime 112 can receive an invocation of a remote memory-enabled local memory allocation function call, such as rmalloc or rmmap, from application 110. In response, user-space RMP runtime 112 can invoke the corresponding standard memory allocation function call (e.g., malloc or mmap) provided by runtime 112's language runtime system and thereby allocate the requested amount of local memory in the virtual address space of application 110 (block 404).

Upon allocating local memory per block 404, user-space RMP runtime 112 can map the virtual memory starting address and size of the allocated local memory to an available portion of a pre-allocated remote memory slab in memory map 126 (block 406). This allows the mapped remote memory to serve as a swap backing store for the allocated local memory, and thus hold pages that are swapped out from that local memory. User-space RMP runtime 112 can record this mapping within memory map 126.

In addition, user-space RMP runtime 112 can register the virtual memory starting address and size of the allocated local memory with kernel 116's user-space page fault delegation mechanism (e.g., userfaultfd) (block 408). This will cause kernel 116 to automatically notify user-space RMP runtime 112 (or more precisely, page fault handler 120 of runtime 112) whenever a page fault is raised with respect to a page within that specified virtual address range, which in turn enables page fault handler 120 to handle the page fault in user space. The particular way in which kernel 116 performs this notification can vary depending on the design of the page fault delegation mechanism. For example, in the case of userfaultfd, kernel 116 will write the page fault notification to an I/O resource (i.e., a userfaultfd object) via a file descriptor that is made available to page fault handler 120.

Finally, at block 410, user-space RMP runtime 112 can return a pointer to the newly-allocated local memory to application 110.

### 6. Page Fault Handling

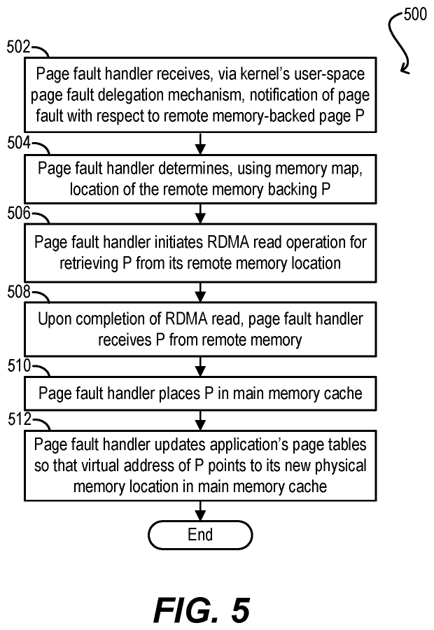

FIG. 5 depicts a workflow 500 that may be executed by page fault handler 120 for handling a page fault that is raised with respect to a remote memory-backed page of application 110 according to certain embodiments.

Starting with block 502, page fault handler 120 can receive, via the page fault delegation mechanism of kernel 116, a notification of a page fault for a remote memory-backed memory page P.

In response, page fault handler 120 can determine, using memory map 126, the location (i.e., remote memory server and slab address) of the remote memory portion that backs the content of page P (block 504) and can initiate an RDMA read operation in order to retrieve page P from that remote memory location (block 506).

Finally, page fault handler 120 can receive page P upon completion of the RDMA read (block 508), place P in the main memory cache of application 110 (block 510), and update application 110's page tables so that the virtual address of P points to its new physical memory location in the main memory cache, thereby enabling application 110 to read it (block 512).

In some embodiments, rather than having page fault handler 120 wait for completion of the RDMA read initiated at block 510, a separate poller thread of user-space RMP runtime 112 can handle this task. This approach allows page fault handler 120 to proceed with processing further page faults upon initiating the RDMA read operation, resulting in greater parallelism and improved performance. In these embodiments, once the RDMA read is completed, the poller thread can execute the remaining steps of workflow 500 (i.e., blocks 510 and 512).

### 7. Eviction Handling

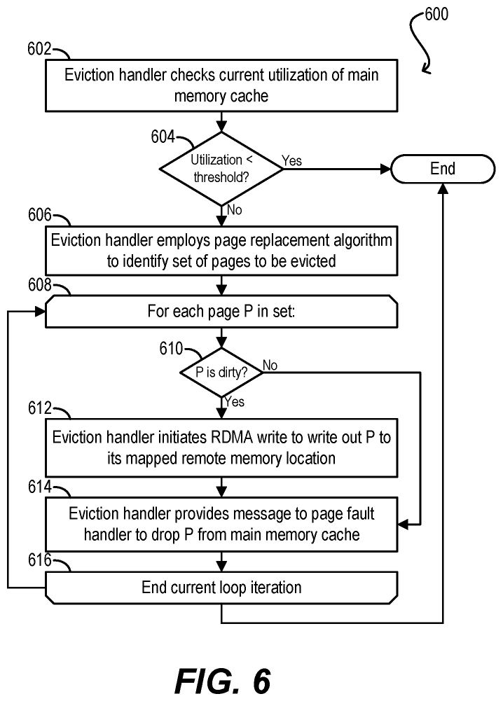

FIG. 6 depicts a workflow 600 that may be executed by eviction handler 122 for evicting pages from the main memory cache of application 110 according to certain embodiments, thereby ensuring that the main memory cache has sufficient free space for holding memory pages swapped in from remote memory. It is assumed that workflow 600 is repeated by eviction handler 122 on a periodic basis, such as every m seconds or minutes.

Starting with block 602, eviction handler 122 can check the current utilization of the main memory cache. If the utilization is below a threshold (block 604), workflow 600 can end.

However, if the utilization is at or above the threshold, eviction handler 122 can employ a page replacement algorithm to identify a set of pages to be evicted from the main memory cache (block 606). Eviction handler 122 can use any page replacement algorithm known in the art for this purpose, such as LRU (least recently used), FIFO (first in first out), and so on.

At block 608, eviction handler 122 can enter a loop for each page P identified at block 606. Within this loop, eviction handler 122 can determine (using, e.g., application 110's page tables), whether page P is dirty (i.e., has been written to) (block 610). If the answer is yes, eviction handler 122 can initiate an RDMA write operation to write out page P to its mapped remote memory location as recorded in memory map 126 (block 612).

Eviction handler 122 can then provide a message to page fault handler 120 to drop page P from the main memory cache (block 614). This will cause page fault handler 120 to un-map page P in application 110's page tables from its physical location in the main memory cache, which in turn will cause a page fault to be raised if application 110 attempts to access page P in the future.

Finally, eviction handler 122 can reach the end of the current loop iteration (block 616) and can return to the top of the loop to handle any further pages to be evicted.

In some embodiments, a separate poller thread can be used to wait for completion of the RDMA write initiated by eviction handler 122 at block 612, in a manner similar to the poller thread described with respect to page fault handler 120. In a particular embodiment, this poller thread may be the same thread used to assist page fault handler 120.

### 8. Function Interposition

As mentioned previously, in certain embodiments user-space RMP runtime 112 can include a function interposer that is configured to hook standard memory allocation/deallocation functions such as malloc, free, mmap, etc. that are exposed by runtime 112's underlying language runtime system (e.g., C language runtime system). This allows runtime 112 to provide transparent remote memory paging support for legacy applications that make calls to these standard functions.

To enable this functionality, the function interposer can be loaded at the time of initiating application 110 (via, e.g., the LD_PRELOAD mechanism of Linux, or any other similar mechanism). This will cause the function interposer to automatically intercept invocations made by application 110 to malloc, free, mmap, and the like. Upon intercepting these standard function calls, the function interposer can automatically invoke the corresponding remote memory-enabled versions exposed by user-space RMP runtime 112 (e.g., rmalloc, rfree, rmmap, etc.).

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
allocating, by a user-space runtime running on a computer system, a region of remote memory residing on another computer system;
receiving, by the user-space runtime from an application, a call to a memory allocation function;
in response to receiving the call, allocating, by the user-space runtime, a range of local memory in a virtual address space of the application; and
mapping, by the user-space runtime in a map data structure, the range of local memory to the region of remote memory, the mapping indicating that the region of remote memory is a swap backing store for the range of local memory.

2. The method of claim 1 further comprising:
registering the range of local memory with a user-space page fault delegation mechanism provided by a kernel of the computer system.

3. The method of claim 2 further comprising:
receiving, by a page fault handler of the user-space runtime from the kernel, a notification of a page fault raised in response to a memory access made by the application to a page in the range of local memory;
in response to receiving the notification, determining, by the page fault handler, a remote memory location of the page based on the map data structure, the remote memory location identifying said another computer system and an address in the region of remote memory;
retrieving, by the page fault handler, the page from the remote memory location via a Remote Direct Memory Access (RDMA) read operation; and
storing the retrieved page in a main memory cache associated with the application.

4. The method of claim 3 further comprising:
checking, by an eviction handler of the user-space runtime, a utilization level of the main memory cache; and
upon determining that the utilization level exceeds a threshold:
identifying, by the eviction handler, a candidate page to be evicted from the main memory cache, the candidate page being mapped to another remote memory location;
checking, by the eviction handler, whether the candidate page is dirty; and
upon determining that the candidate page is dirty, writing the candidate page to said another remote memory location via an RDMA write operation.

5. The method of claim 1 wherein the allocating is performed prior to receiving the call to the memory allocation function.

6. The method of claim 1 wherein the memory allocation function is a standard memory allocation function exposed by a language runtime system of the user-space runtime, and wherein the receiving comprises:
intercepting the call to the standard memory allocation function via a function interposer; and
invoking a remote memory-enabled version of the standard memory allocation function.

7. The method of claim 1 wherein the memory allocation function is a remote memory-enabled version of a standard memory allocation function exposed by a language runtime system of the user-space runtime.

8. A non-transitory computer readable storage medium having stored thereon program code executable by a user-space runtime running on a computer system, the program code embodying a method comprising:
allocating a region of remote memory residing on another computer system;
receiving from an application a call to a memory allocation function;
in response to receiving the call, allocating a range of local memory in a virtual address space of the application; and
mapping, in a map data structure, the range of local memory to the region of remote memory, the mapping indicating that the region of remote memory is a swap backing store for the range of local memory.

9. The non-transitory computer readable storage medium of claim 8 wherein the method further comprises:
registering the range of local memory with a user-space page fault delegation mechanism provided by a kernel of the computer system.

10. The non-transitory computer readable storage medium of claim 9 wherein the method further comprises:
receiving, by a page fault handler of the user-space runtime from the kernel, a notification of a page fault raised in response to a memory access made by the application to a page in the range of local memory;
in response to receiving the notification, determining, by the page fault handler, a remote memory location of the page based on the map data structure, the remote memory location identifying said another computer system and an address in the region of remote memory;
retrieving, by the page fault handler, the page from the remote memory location via a Remote Direct Memory Access (RDMA) read operation; and
storing the retrieved page in a main memory cache associated with the application.

11. The non-transitory computer readable storage medium of claim 10 wherein the method further comprises:
checking, by an eviction handler of the user-space runtime, a utilization level of the main memory cache; and
upon determining that the utilization level exceeds a threshold:
identifying, by the eviction handler, a candidate page to be evicted from the main memory cache, the candidate page being mapped to another remote memory location;
checking, by the eviction handler, whether the candidate page is dirty; and
upon determining that the candidate page is dirty, writing the candidate page to said another remote memory location via an RDMA write operation.

12. The non-transitory computer readable storage medium of claim 8 wherein the allocating is performed prior to receiving the call to the memory allocation function.

13. The non-transitory computer readable storage medium of claim 8 wherein the memory allocation function is a standard memory allocation function exposed by a language runtime system of the user-space runtime, and wherein the receiving comprises:
intercepting the call to the standard memory allocation function via a function interposer; and
invoking a remote memory-enabled version of the standard memory allocation function.

14. The non-transitory computer readable storage medium of claim 8 wherein the memory allocation function is a remote memory-enabled version of a standard memory allocation function exposed by a language runtime system of the user-space runtime.

15. A computer system comprising:
a processor; and
a non-transitory computer readable medium having stored thereon program code for a user-space runtime that, when executed, causes the processor to:
allocate a region of remote memory residing on another computer system;
receive from an application a call to a memory allocation function;
in response to receiving the call, allocate a range of local memory in a virtual address space of the application; and
map, in a map data structure, the range of local memory to the region of remote memory, the mapping indicating that the region of remote memory is a swap backing store for the range of local memory.

16. The computer system of claim 15 wherein the program code further causes the processor to:
register the range of local memory with a user-space page fault delegation mechanism provided by a kernel of the computer system.

17. The computer system of claim 16 wherein the program code further causes the processor to:
receive, from the kernel, a notification of a page fault raised in response to a memory access made by the application to a page in the range of local memory;
in response to receiving the notification, determine a remote memory location of the page based on the map data structure, the remote memory location identifying said another computer system and an address in the region of remote memory;
retrieve the page from the remote memory location via a Remote Direct Memory Access (RDMA) read operation; and
store the retrieved page in a main memory cache associated with the application.

18. The computer system of claim 17 wherein the program code further causes the processor to:
check a utilization level of the main memory cache; and
upon determining that the utilization level exceeds a threshold:
identify a candidate page to be evicted from the main memory cache, the candidate page being mapped to another remote memory location;
check whether the candidate page is dirty; and
upon determining that the candidate page is dirty, write the candidate page to said another remote memory location via an RDMA write operation.

19. The computer system of claim 15 wherein the allocating is performed prior to receiving the call to the memory allocation function.

20. The computer system of claim 15 wherein the memory allocation function is a standard memory allocation function exposed by a language runtime system of the user-space runtime, and wherein the program code that causes the processor to receive the call to the standard memory allocation function comprises program code that causes the processor to:
intercept the call to the standard memory allocation function via a function interposer; and
invoke a remote memory-enabled version of the standard memory allocation function.

21. The computer system of claim 15 wherein the memory allocation function is a remote memory-enabled version of a standard memory allocation function exposed by a language runtime system of the user-space runtime.
